(19) United States
(12) Patent Application Publication
(10) Pub. No.: US 2016/0221884 A1
(43) Pub. Date: Aug. 4, 2016

(54) CONCRETE FORMULATIONS AND ADMIXTURES THEREFOR

(71) Applicants: TECHNION RESEARCH & DEVELOPMENT FOUNDATION LTD., Haifa (IL); LARISPLAST LTD., Kiyrat Gat (IL)

(72) Inventors: Khaskel GANDELMAN, Rehovot (IL); Larisa LEIZEROVICH, Moshav Beit Nehemia (IL); Konstantin KOVLER, Nesher (IL); Dmitry MOLOGIN, Haifa (IL)

(73) Assignee: Technion Research & Development Foundation Ltd., Haifa (IL)

(21) Appl. No.: 15/023,122

(22) PCT Filed: Sep. 18, 2013
(86) PCT No.: PCT/IB2013/058627

§ 371 Date: Mar. 18, 2016

(51) Int. Cl. C04B 40/00; C04B 22/16; C04B 28/02

(52) U.S. Cl. CPC C04B 40/0039; C04B 28/02; C04B 22/16

(57) ABSTRACT

A chemical formulation including: (a) at least one cement dispersant selected to disperse cementitious particles disposed in a water-based, flowable cementitious mixture, the cement dispersant including a polyphosphate; (b) a surfactant selected to reduce a surface tension of the mixture; (c) an accelerator selected to accelerate setting of the mixture; the formulation containing at least 200 grams of the polyphosphate per mole of an oxyalkalene functional group within the formulation.

### FIELD OF THE INVENTION

The present invention relates to concrete formulations and admixtures therefor.

### BACKGROUND OF THE INVENTION

At present, synthetic admixtures are widely used in concrete production, mainly as plasticizers or superplasticizers. The most popular plasticizing admixtures are based on lignosulfonate (LS), melamine sulfonates (MS), sulfonated naphthalene formaldehyde condensate (SNF) and polycarboxylates (PC). The main plasticizing admixtures have a complex, multi-component composition: they consist of one or several mentioned above compounds as active components and surfactants.

Constantly growing consumption of lignin in non-construction sectors, together with deforestation, make lignosulfonate admixtures less available for concrete industry now. The manufacture of naphthalene-synthesized admixtures is associated with potential harmful environmental effect. Polycarboxylates are still quite expensive. Such chemicals as ammonia, formaldehyde and naphthalene are toxic. Workers involved in their manufacture or application and exposed to the emissions from them or their intermediate products may be at a risk of developing health problems. Emissions from these production facilities may subject surrounding communities to increased health risks from air and water pollution.

Several patent documents refer to the use of sodium tripolyphosphate (STP) or polyphosphate, in mixtures containing cement and water. U.S. Pat. No. 4,930,428 discloses a concrete composition in which the water contains sodium tripolyphosphate.

U.S. Pat. Nos. 6,670,415 and 6,352,952 disclose admixtures containing an EO/PO plasticizer and a clay-activity modifying agent. The clay-activity modifying agent may include a wide variety of species, including “an inorganic cation, an organic cation, a polar organic molecule capable of being absorbed by the clay, a clay dispersant (such as a polyphosphate), or a mixture thereof”. In particular, U.S. Pat. Nos. 6,670,415 and 6,352,952 refer to the use of polyphosphates and STP at a dosage of about 0.04 weight percent, by mass of cement.

It must be further emphasized that U.S. Pat. Nos. 6,670,415 and 6,352,952 teach the use of polyphosphates as clay-activity modifying agents and not as cement dispersants, and include, in the disclosed admixtures, a dedicated cement dispersant. Moreover, the use of polyphosphates in cements having little or no swelling clays would appear to be unwarranted, based on this background art.

The inventors have perceived a need for further improvements in concrete admixtures and formulations.

### SUMMARY OF THE INVENTION

According to the teachings of the present invention there is provided a chemical formulation including: (a) at least one cement dispersant selected to disperse cementitious particles disposed in a water-based, flowable cementitious mixture, the cement dispersant including a polyphosphate; (b) a surfactant selected to reduce a surface tension of the mixture; (c) an accelerator selected to accelerate setting of the mixture; the formulation containing at least 200 grams of the polyphosphate per mole of an oxyalkalene functional group within the formulation.

According to further features in the described preferred embodiments, the formulation contains at least 300 grams, at least 600 grams, at least 1000 grams, at least 1500 grams, at least 2000 grams, at least 3000 grams, at least 5000 grams, at least 10000 grams, at least 15000 grams, or at least 20000 grams of the polyphosphate, per mole of the oxyalkalene functional group.

According to still further features in the described preferred embodiments, the formulation contains at least 0.3 weight %, at least 0.5 weight %, at least 0.75 weight %, or at least 0.85 weight % of the polyphosphate.

According to still further features in the described preferred embodiments, the formulation includes at least one polymer containing at least one type of the oxyalkalene functional group, and wherein a weight ratio of the polyphosphate to the at least one polymer, within the formulation, is at least 3:1, at least 5:1, at least 10:1, at least 15:1, at least 20:1, at least 30:1, or at least 40:1.

According to still further features in the described preferred embodiments, the formulation contains less than 2%, less than 1%, less than 0.5%, less than 0.3%, less than 0.2%, or less than 0.1% of the oxyalkylene polymer, on a weight basis.

According to still further features in the described preferred embodiments, the ratio of the polyphosphate to a total weight of the at least one cement dispersant, within the formulation, is at least 0.5:1, by weight.

According to still further features in the described preferred embodiments, the pH of the formulation is at least 8.2, at least 8.4, at least 8.6, or at least 8.8.

According to still further features in the described preferred embodiments, the pH of the formulation is at most 10.5, at most 10.2, at most 10, or at most 9.8.

According to still further features in the described preferred embodiments, the pH is within a range of 8.2 to 10.5, within a range of 8.4 to 10.2, or within a range of 8.6 to 10.

According to still further features in the described preferred embodiments, the weight ratio of the polyphosphate to the at least one cement dispersant, is at least 0.50:1, at least 0.60:1, at least 0.70:1, at least 0.80:1, at least 0.90:1, at least 0.95:1, or substantially 1:1.

According to still further features in the described preferred embodiments, the oxyalkalene functional group includes, largely includes, mainly includes, or predominantly includes ethylene oxide.

According to still further features in the described preferred embodiments, the oxyalkalene functional group consists essentially of ethylene oxide.

According to still further features in the described preferred embodiments, the polyphosphate includes a polyphosphate selected from the group consisting of a sodium polyphosphate and a potassium polyphosphate.

According to still further features in the described preferred embodiments, the polyphosphate includes sodium tripolyphosphate (Na₅P₃O₁₀).

According to still further features in the described preferred embodiments, the accelerator includes a polyethanolamine.

According to still further features in the described preferred embodiments, the accelerator includes a triethanolamine (TEA).

According to still further features in the described preferred embodiments, the surfactant includes, largely includes, predominantly includes, or consists essentially of a non-ionic surfactant.

According to still further features in the described preferred embodiments, the surfactant includes a nonylphenol ethoxylate.

According to still further features in the described preferred embodiments, the formulation further includes at least one cement retardant, selected to retard the setting of the water-based, flowable cementitious mixture.

According to still further features in the described preferred embodiments, the cement retardant includes at least one sugar.

According to still further features in the described preferred embodiments, the formulation is a paste.

According to still further features in the described preferred embodiments, the formulation further includes at least one polar solvent.

According to still further features in the described preferred embodiments, the polar solvent includes, largely includes, or predominantly includes at least one alcohol.

According to still further features in the described preferred embodiments, the formulation contains 0.001%-0.03%, or 0.01%-0.03%, by weight, of the alcohol.

According to still further features in the described preferred embodiments, the alcohol includes, largely includes, or predominantly includes isopropyl alcohol.

According to still further features in the described preferred embodiments, the formulation contains 0.001%-0.05%, or 0.01%-0.03%, by weight, of the isopropyl alcohol.

According to still further features in the described preferred embodiments, the polar solvent includes water.

According to still further features in the described preferred embodiments, the formulation further includes at least one biocide.

According to still further features in the described preferred embodiments, the biocide includes formaldehyde.

According to still further features in the described preferred embodiments, the biocide includes (ethylenedioxy) dimethanol 2-Octyl-2-H-isothiazol-3-one.

According to still further features in the described preferred embodiments, the surfactant includes a nonylphenol ethoxylate, and the accelerator includes triethanolamine.

According to still further features in the described preferred embodiments, the formulation contains 0.01-0.06% of the nonylphenol ethoxylate.

According to still further features in the described preferred embodiments, the formulation contains 1.0-5.0%, by weight, of the triethanolamine.

According to still further features in the described preferred embodiments, the formulation contains at least 1.0%, at least 1.2%, at least 1.5%, or at least 2%, by weight, of the polyphosphate.

According to still further features in the described preferred embodiments, the formulation contains 1.0-5.0%, 1.2-5.0%, 1.5-5.0%, 1.8-4.5%, 2.0-4.0%, or 2.0-3.5%, by weight, of the polyphosphate.

According to still further features in the described preferred embodiments, the formulation contains less than 5.0%, less than 4.5%, less than 4.0%, less than 3.5%, or less than 3.0%, by weight, of the polyphosphate.

According to still further features in the described preferred embodiments, the formulation contains 5-14%, by weight, of at least one sugar.

According to still further features in the described preferred embodiments, the formulation further includes a cement.

According to still further features in the described preferred embodiments, the formulation further includes mixing water in sufficient quantity for complete hydration of the cement.

According to still further features in the described preferred embodiments, the weight ratio of the mixing water to the cement is at least 0.15 or at least 0.20.

According to still further features in the described preferred embodiments, the formulation further includes an aggregate material.

According to still further features in the described preferred embodiments, the formulation is a cementitious mixture.

According to still further features in the described preferred embodiments, the formulation contains, by weight, at most 0.5% smectite clay, at most 0.3% smectite clay, at most 0.2% smectite clay, at most 0.1% smectite clay, or the formulation is substantially free of smectite clay.

According to still further features in the described preferred embodiments, the formulation contains, by weight, at most 0.5% clay, at most 0.3% clay, at most 0.2% clay, at most 0.1% clay, or the formulation is substantially free of clay.

According to still further features in the described preferred embodiments, the formulation contains at least 5000 kilograms, at least 10000 kilograms, at least 20000 kilograms, at least 30000 kilograms, at least 50000 kilograms, at least 75000 kilograms, at least 100000 kilograms, or at least 150000 kilograms of the cement, per mole of the oxyalkalene functional group within the formulation.

According to still further features in the described preferred embodiments, the weight ratio of the surfactant to the cement, within the formulation, is within a range of 1×10⁻⁶ to 6×10⁻⁶.

According to still further features in the described preferred embodiments, the weight ratio of the at least one dispersant to the cement within the formulation is within a range of 3×10⁻⁵ to 5×10⁻⁴.

According to still further features in the described preferred embodiments, the weight ratio of the accelerator to the cement within the formulation is within a range of 1×10⁴ to 5×10⁴.

According to still further features in the described preferred embodiments, the weight ratio of the cement retardant to the cement within the formulation is within a range of 5×10⁻⁴ to 1.4×10⁻³.

According to still further features in the described preferred embodiments is provided a method of producing a cementitious mixture, including: (a) providing all components of the formulation of any one of claims 39-50; and (b) mixing the components to produce the cementitious mixture.

According to another aspect of the present invention there is provided a chemical formulation including: (a) at least one cement dispersant; and (b) a surfactant; the at least one cement dispersant including a polyphosphate, the formulation including at least one polymer containing at least one type of oxyalkalene functional group, and wherein a ratio of the polyphosphate to the at least one polymer, within the formulation, is at least 3:1, by weight.

According to still further features in the described preferred embodiments, the ratio is at least 3:1, at least 5:1, at least 10:1, at least 15:1, at least 20:1, at least 30:1, or at least 40:1.

### DESCRIPTION OF THE PREFERRED EMBODIMENTS

The principles and operation of the cement admixture and formulation according to the present invention may be better understood with reference to the drawings and the accompanying description.

Before explaining at least one embodiment of the invention in detail, it is to be understood that the invention is not limited in its application to the details set forth in the following description. The invention is capable of other embodiments or of being practiced or carried out in various ways. Also, it is to be understood that the phraseology and terminology employed herein is for the purpose of description and should not be regarded as limiting.

One aspect of the invention relates to a water reducing additive for concrete, composed of synthetic polymers, which has been especially designed as an alternative admixture to the typical existing modem complex water reducing admixtures, which include lignosulfonates, melamine sulfonates, naphthalene-synthesized compounds or polycarboxylates. The proposed admixture has been developed purposely to produce easy pumpable concrete with low cement content. The invention is able to maintain the common characteristics of concrete over a long period of time. The proposed admixture, in comparison with modern multi-component ones, may be more flowable, may exhibit better compatibility with different types of cement and aggregates, may demand less power for manufacture, and/or may consist of commonly available nontoxic chemicals.

One embodiment of the present invention is a low-cost, effective plasticizing/water-reducing admixture for producing different types of concrete. In various embodiments, the admixture may be used to increase the workability of the concrete, to produce concrete at low water to cement (w/c) ratios, or to reduce both water and cement contents in the mix. In various embodiments, the admixture may be used in the manufacturing of flowable concrete mixes, normal-strength Portland cement concretes and high-strength/high-performance concretes. In various embodiments, the admixture may be used in the production of concrete with any of various mineral additives, such as fly ash, microsilica, ground granulated blast furnace slag, and metakaolin, concretes reinforced with various types of fibers, and lightweight concretes.

In various embodiments, the admixture may enhance mix rheology, improve workability of concrete at a given water to cement ratio, and/or improve concrete compressive strength at a given effective water to cement (w/c)_{eff} ratio, which takes into account the content of entrained air. In various embodiments, the admixture may enable the use of cements and/or aggregates of marginal quality for manufacturing concrete.

In one embodiment, the admixture formulation contains at least one polyphosphate, such as sodium polyphosphate or potassium polyphosphate. Without wishing to be limited by theory, the inventors believe that the polyphosphate acts as an active cement dispersant for promoting the dispersion of cement particles.

The polyphosphate may be combined with a cement accelerator selected to accelerate the hardening of concrete or other cementitious materials. We have discovered that an accelerator may accelerate the heterogeneous hydration process, which takes place on the surface of cement grains, without detracting from the efficacy of the polyphosphate.

The polyphosphate may be combined with a surfactant selected to reduce a surface tension of fresh concrete or cementitious materials. We have discovered that such a surfactant may improve the rheological characteristics and/or the stability of the fresh mixes.

The admixture formulation may further contain at least one retardant for decelerating the setting of the concrete or cementitious materials.

The admixture formulation may further contain at least one solvent for diluting the admixture.

The admixture formulation may further contain at least one protecting agent or biocide selected and provided in a dose that inhibits or appreciably retards bacterial growth.

More particularly, the admixture formulation may contain, by weight of the admixture:
(a) about 0.3-5.0% polyphosphate such as sodium tripolyphosphate (STP), typically at least 0.6% or at least 0.8%, and more typically 1.0-5.0%, 1.2-5.0%, 1.5-5.0%, 1.5-4.0%, or 1.5-3.0%;
(b) about 1.0-5.0% cement accelerator such as triethanolamine (TEA); and
(c) about 0.01-0.06% surfactant such as a non-ionic surfactant, for example, nonylphenol ethoxylate.

The admixture formulation may further contain, by weight of the admixture:
(d) about 5-14% sugars; and/or
(e) about 0.01-0.03% polar solvent such as an alcohol, for example, isopropyl alcohol; and/or
(f) about 0.1-0.5% biocide, such as an aqueous solution of (ethylenedioxy) dimethanol 2-Octyl-2 H-isothiazol-3-one(often called Mergal V698-K-4), or formalin (aqueous solution of about 37% formaldehyde and about 10% methanol); and/or
(g) an additional solvent such as water (typically about 75-92%).

The inventive admixture is physically, chemically, and biologically stable. In particular, chemical stability of the admixture may be enhanced by triethanolamine. This ingredient may contribute to a high pH, preventing or greatly reducing the possible hydrolysis of STP. We have discovered that at a pH of at least 8.2, at least 8.4, at least 8.6, or at least 8.8, the formulation may be appreciably stabilized. The pH of the admixture may be at most 10.5, at most 10.2, at most 10, or at most 9.8. Typically, the pH of the admixture is within a range of 8.2 to 10.5, within a range of 8.4 to 10.2, or within a range of 8.6 to 10.

The decomposition caused by bacterial activity may be suppressed by a biocide, particularly by (ethylenedioxy) dimethanol 2-Octyl-2 H-isothiazol-3-one or formalin (an aqueous solution of formaldehyde and methanol).

We have found that in a closed bottle, the inventive admixture may have a shelf life, at room temperature, of at least 1 year, at least 2 years, or at least 3 years. The admixture maintains physical (e.g., phase stability), chemical, and biological stability, and remains efficacious as a cement admixture.

Exemplary admixture compositions are provided in Table 1.

The performance of the admixture of the invention was tested against a reference cement paste containing Rheobuild 700 IL admixture (RH 700)—a superplasticizer admixture containing 25-35% polyethanolamine, 0.5-1% alkyl olefin sulfonate, and possibly lignosulfonate and other components. This admixture is commercially available from BASF (Badische Anilin & Soda Fabrik).

TABLE 1

| | Composition, wt % | | |
|---|---|---|---|
| | Admixture | | |
| Mix Components | EXAMPLE 1 | EXAMPLE 2 | EXAMPLE 3 |
| Sodium | 2.00 | 1.00 | 3.00 |
| Tripolyphosphate | | | |
| Triethanolamine | 3.00 | 2.00 | 5.00 |
| Sugars | 11.00 | 14.00 | 14.00 |
| Nonylphenol | 0.06 | 0.06 | 0.06 |
| ethoxylate | | | |
| Isopropyl | 0.03 | 0.03 | 0.03 |
| Alcohol | | | |
| Mergal V698-K- | 0.50 | 0.50 | 0.50 |
| 4 or formalin | | | |
| Water | 83.41 | 82.41 | 77.41 |

We prepared several cement pastes, three of which (samples 1-3) contained the admixtures prepared in accordance with Table 1, and one of which contained the RH 700 admixture. Details of mix proportions for the samples and the results of the consistency test and compressive strength test of the 25 mm cubes are provided in Table 2.

As may be evident from Table 2, all the mixes containing the inventive admixtures exhibit increased flowability with respect to the reference mix. At the same time, the compressive strengths of the cement pastes containing the inventive admixtures are higher than those of the reference paste. In comparison with the reference sample, the compressive strength at the 28th day is improved for mixes 1 and 3. The strength of mix 2 was similar to that of the reference.

TABLE 2
Mix Proportions, Consistency and Compressive
Strength of Cement Pastes

| | | RH 700 | EXAM- | EXAM- | EXAM- |
|---|---|---|---|---|---|
| Mix | | Reference | PLE 1 | PLE 2 | PLE 3 |
| mass of admixture by weight | | 0.85 | 0.85 | 0.85 | 0.85 |
| of cement (CEMI 52.5N), % | | | | | |
| water-cement ratio (w/c) | | 0.3 | 0.3 | 0.3 | 0.3 |
| Consistency, mm | | 215 | 218 | 217 | 222 |
| compressive | 3^{rd} day | 47.7 | 52.2 | 50.0 | 51.8 |
| strength | 7^{th} day | 51.1 | 55.9 | 58.4 | 66.1 |
| (MPa) | 28^{th} day | 66.3 | 73.1 | 67.4 | 72.8 |

Without wishing to be limited by theory, the inventors believe that the cement hydration proceeds more quickly and more completely for the mixes containing the inventive admixtures 1-3.

An additional series of the tests was made at w/c=0.33. The results obtained for the samples containing the admixture of EXAMPLE 2 (see Table 1) and RH 700 are presented in Table 3.

TABLE 3
Samples with w/c = 0.33

| Type | mass by | | | | compressive | | |
|---|---|---|---|---|---|---|---|
| of | weight of | cement | | | strength, MPa | | |
| admix- | cement, | (52.5N), | water, | slump, | 3^{rd} | 7^{th} | 28^{th} |
| ture | % | kg | kg | mm | day | day | day |
| RH 700 | 0.85 | 2 | 0.66 | 238 | 37.2 | 42.6 | 60.6 |
| EXAM- | 0.85 | 2 | 0.66 | 262 | 42.3 | 61.5 | 83.5 |
| PLE 2 | | | | | | | |

It may be seen from Table 3 that the compressive strength developed in the inventive sample containing the inventive admixture 2 is higher than that of the reference mix, at all tested time periods. Moreover, the inventive sample containing admixture 2 exhibits enhanced flowability.

Further tests were performed for exemplary inventive specimens containing the inventive admixture 2 and for reference specimens containing RH 700. The details of the mix proportions for the samples and the results of the slump flow test and the compressive strength test are provided in Table 4.

It may be seen from Table 4 that the inventive formulations containing admixture 2 yield higher compressive strengths (for two different types of cement), with respect to the reference formulations, at all tested time periods.

TABLE 4
Samples with w/c = 0.6

| | | | EXAM- | | EXAM- |
|---|---|---|---|---|---|
| Admixture type | | RH 700 | PLE 2 | RH 700 | PLE 2 |
| Cement type | | CEM I | CEM I | CEM II | CEM II |
| | | 52.5N | 52.5N | 42.5N | 42.5N |
| mass by weight of cement, % | | 1.0 | 1.0 | 1.0 | 1.0 |
| Cement, kg | | 280 | 280 | 280 | 280 |
| Water, kg | | 168 | 168 | 168 | 168 |
| water-cement ratio (w/c) | | 0.6 | 0.6 | 0.6 | 0.6 |
| Compressive | 1^{st} day | 3.3 | 4.4 | 2.5 | 3.5 |
| strength | 7^{th} day | 24.4 | 34.7 | 24.2 | 27.7 |
| | 28^{th} day | 35.1 | 48.6 | 36.0 | 42.5 |

### EXAMPLE 4

Using the admixture formulation of EXAMPLE 2, the ratio of polyphosphate (weight) to oxyalkalene functional groups (moles) is calculated as follows:
sodium tripolyphosphate: 1%=1 gram.
nonylphenol ethoxylate: 0.06%=0.06 grams=9.71×10⁻⁵ moles=8.77×10⁻⁴ moles EO. (9 ethylene oxide groups/mole nonylphenol ethoxylate)
→1 gram STP/8.77×10⁻⁴ moles EO=1141 g STP/mole EO.

### EXAMPLE 5

Using the minimum polyphosphate concentration (0.3%) within the range (0.3-5.0%) provided above, and the maximum concentration (0.06%) of non-ionic surfactant (nonylphenol ethoxylate) within the range (0.01-0.06%) provided above, the ratio of polyphosphate (weight) to oxyalkalene functional groups (moles) is calculated as follows:
sodium tripolyphosphate: 0.3%=0.3 grams.
nonylphenol ethoxylate: 0.06%=0.06 grams=9.71×10⁻⁵ moles=8.77×10⁻⁴ moles EO. (9 ethylene oxide groups/mole nonylphenol ethoxylate)
→342 g STP/mole EO.

### EXAMPLE 6

Using the a intermediate polyphosphate concentration (2.5%) within the range (0.3-5.0%) provided above, and the maximum concentration (0.06%) of non-ionic surfactant (nonylphenol ethoxylate) within the range provided above, the ratio of polyphosphate (weight) to oxyalkalene functional groups (moles) is calculated as follows:
sodium tripolyphosphate: 2.5%=2.5 grams.
nonylphenol ethoxylate: 0.035%=0.035 grams=5.66×10⁻⁵ moles=5.1×10⁻⁴ moles EO. (9 ethylene oxide groups/mole nonylphenol ethoxylate)
→4,902 g STP/mole EO.
   (a) about 0.3-5.0% polyphosphate such as sodium tripolyphosphate (STP), typically at least 0.6% or at least 0.8%, and more typically 1.0-5.0%, 1.2-5.0%, 1.5-5.0%, 1.5-4.0%, or 1.5-3.0%;
   (b) about 1.0-5.0% cement accelerator such as triethanolamine (TEA); and
   (c) about 0.01-0.06% surfactant such as a non-ionic surfactant, for example, nonylphenol ethoxylate.

As used herein in the specification and in the claims section that follows, the term “percent”, or “%”, refers to percent by weight, unless specifically indicated otherwise.

Similarly, the term “ratio”, as used herein in the specification and in the claims section that follows, refers to a weight ratio, unless specifically indicated otherwise.

As used herein in the specification and in the claims section that follows, the term “largely includes”, with respect to a component within a formulation, refers to a weight content of at least 30%.

As used herein in the specification and in the claims section that follows, the term “predominantly includes”, with respect to a component within a formulation, refers to a weight content of at least 65%.

As used herein in the specification and in the claims section that follows, the term “weight of polyphosphate” is meant to include the weight of the cation (typically sodium or potassium) in addition to the polyphosphate anion.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, including U.S. Pat. Nos. 4,930,428, 6,670,415 and 6,352,952, are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1.-52. (canceled)

53. A chemical formulation comprising:
(a) at least one cement dispersant selected to disperse cementitious particles disposed in a water-based, flowable cementitious mixture;
(b) a surfactant selected to reduce a surface tension of said water-based, flowable cementitious mixture;
(c) an accelerator selected to accelerate setting of said water-based, flowable cementitious mixture,
said at least one cement dispersant including a polyphosphate,
the formulation containing at least 200 grams of said polyphosphate per mole of an oxyalkalene functional group within the formulation.

54. The formulation of claim 53 comprising one or more of the following components:
at least 0.3 weight %, a of said polyphosphate;
at least one polymer containing at least one type of said oxyalkalene functional group, and wherein a weight ratio of said polyphosphate to said at least one polymer, within the formulation, is at least 3:1;
a cement retardant, selected to retard said setting of said water-based, flowable cementitious mixture, optionally wherein said cement retardant includes at least one sugar;
at least one polar solvent;
at least one biocide, optionally wherein said biocide is selected from formaldehyde
and (ethylenedioxy) dimethanol 2-Octyl-2-H-isothiazol-3-one.

55. The formulation of claim 53, the formulation including at least one polymer containing at least one type of said oxyalkalene functional group, and wherein a weight ratio of said polyphosphate to said at least one polymer, within the formulation, is at least 3:1, optionally wherein the formulation containing less than 2% of said oxyalkylene polymer, on said weight basis.

56. The formulation of claim 53, a ratio of said polyphosphate to a total weight of said at least one cement dispersant, within the formulation, is at least 0.5:1, by weight.

57. The formulation of claim 53, a pH of the formulation being selected from at least 8.2, at least 8.4, at least 8.6, at least 8.8, at most 10.5, at most 10.2, at most 10, or at most 9.8.

58. The formulation of claim 53, wherein a weight ratio of said polyphosphate to said at least one cement dispersant, is at least 0.50:1.

59. The formulation of claim 53, wherein said oxyalkalene functional group comprises ethylene oxide.

60. The formulation of claim 53, wherein said polyphosphate includes a polyphosphate selected from the group consisting of a sodium polyphosphate and a potassium polyphosphate.

61. The formulation of claim 53, wherein said accelerator is selected from an accelerator including a polyethanolamine and an accelerator including a triethanolamine (TEA).

62. The formulation of claim 53 wherein said surfactant comprises non-ionic surfactant or nonylphenol ethoxylate.

63. The formulation of claim 54, said polar solvent is selected from 001%-0.03%, by weight, alcohol, 0.001%-0.05%, by weight isopropyl alcohol and water.

64. The formulation of claim 53, said surfactant includes a nonylphenol ethoxylate, and said accelerator includes triethanolamine.

65. The formulation of claim 64, containing at least one of 0.01-0.06% of said nonylphenol ethoxylate and containing 1.0-5.0%, by weight, of said triethanolamine.

66. The formulation of claim 53, the formulation containing at least 1.0 by weight, of said polyphosphate or less than 5.0, by weight, of said polyphosphate.

67. The formulation of claim 53, further comprising a cement.

68. The formulation of claim 67, further comprising one or more of the following components:
water in sufficient quantity for complete hydration of said cement, optionally wherein a weight ratio of said water to said cement is at least 0.15;
an aggregate material;
at most 0.5%, by weight, smectite clay; and
at most 0.5%, by weight, clay.

69. The formulation of claim 67, the formulation containing at least 5000 kilograms of said cement, per mole of said oxyalkalene functional group within the formulation.

70. The formulation of claim 67, having a weight ratio selected from the group consisting of:
a weight ratio of said surfactant to said cement, within the formulation, is within a range of 1×10⁻⁶ to 6×10⁻⁶;
a weight ratio of said at least one dispersant to said cement within the formulation is within a range of 3×10⁻⁵ to 5×10⁻⁴;
a weight ratio of said accelerator to said cement within the formulation is within a range of 1×10⁻⁴ to 5×10⁻⁴; and
a weight ratio of said cement retardant to said cement within the formulation is within a range of 5×10⁻⁴ to 1.4×10⁻³.

71. A method of producing a cementitious mixture, the method comprising the steps of:
(a) providing all components of the formulation of claim 67; and
(b) mixing said components to produce the cementitious mixture.

72. A chemical formulation comprising:
(a) at least one cement dispersant; and
(b) a surfactant;
said at least one cement dispersant including a polyphosphate,
the formulation including at least one polymer containing at least one type of oxyalkalene functional group,
and wherein a ratio of said polyphosphate to said at least one polymer, within the formulation, is at least 3:1, by weight.
